(19) United States
(12) Patent Application Publication
(10) Pub. No.: US 2025/0189357 A1
(43) Pub. Date: Jun. 12, 2025

(54) FILL PROFILE CALCULATION AND OPTIMIZATION

(71) Applicant: DEERE & COMPANY, Moline, IL (US)

(72) Inventor: Riley J. Wegmann, Urbana, IA (US)

(21) Appl. No.: 18/593,384

(22) Filed: Mar. 1, 2024

Related U.S. Application Data
(60) Provisional application No. 63/609,323, filed on Dec. 12, 2023.

(51) Int. Cl. G01F 23/22; G01N 9/00

(52) U.S. Cl. CPC G01F 23/22; G01N 9/00

(57) ABSTRACT

A system and method for optimizing a fill profile of a harvested material in a receiving container. A visual processing unit can use information regarding at least one of a supply container, the receiving container, and the harvested material to determine desired fill profile parameters for harvested material in the receiving container. One or more actual fill profile parameters of the harvested material in the receiving container can be determined by the visual processing unit via use of at least vision data. A comparison by the visual processing unit of the one or more actual fill profile parameters and the desired fill profile parameters can be used in determining an adjustment factor for the fill profile of the harvested material in the receiving container. A signal can also be generated for displaying on a display unit a second fill profile of the harvested material that accounts for the adjustment factor.

### CROSS-REFERENCE TO RELATED APPLICATIONS

The present application is a U.S. non-provisional application that claims the benefit of U.S. provisional application No. 63/609,323, filed on Dec. 12, 2023, which is incorporated herein by reference in its entirety.

### FIELD OF THE DISCLOSURE

The present disclosure relates to supply and receiving containers, and in particular to optimizing a harvested material fill profile for the receiving container.

### BACKGROUND OF THE DISCLOSURE

An agricultural harvester, such as a combine, generally accumulates harvested material during operation. During such harvesting operations, the harvested material from the harvester is transferred to a grain cart or wagon that is towed by a tractor and is positioned next to the harvester as the harvester moves through the field. A transfer mechanism, such as an auger, transfers the agricultural material from the harvester to the grain cart or wagon. Once the grain cart or wagon is sufficiently filled, it is moved to a receiving vehicle such as one or more semi-trailers. The tractor operator must drive to the trailer and position the tractor and grain cart relative to a receiving container assembled with the trailer(s) in order to begin unloading the grain cart.

Typically, a tractor operator determines an amount of harvested material that is to be unloaded or transferred and placed in the receiving container. The tractor operator does not want to underfill or not fill the receiving container to an appropriate amount as this is wasteful and will require more repetitions of loading and unloading the receiving container. The tractor operator does not want to overfill the receiving container as spillage can occur in which harvested material falls or spills out of the receiving container which is also wasteful.

As the field is harvested and the harvested material is transferred to the receiving container certain characteristics of the harvested material affect the placement and amount of harvested material that can be placed in the receiving container. The weight of the harvested material can change over time due to moisture content and other factors that affect the weight of the harvested material and can lead to overfilling or underfilling the receiving container. The tractor operator will fill multiple receiving containers when harvesting a field, therefore potentially either overfilling or underfilling the receiving containers. Overfilling the receiving container can result in exceeding certain weight restrictions when the receiving container is traveling such as on a roadway. The weight of the harvested material can change over time and this can also result in exceeding certain weight restrictions even when the receiving container is underfilled.

Thus, there is a need for improvement for optimization of a fill profile for a receiving container over time that accounts for changes in the harvested material and/or weight restrictions for the receiving container.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of optimizing a fill profile of a harvested material in a receiving container. The method also includes determining, via a visual system, a plurality of desired fill profile parameters for a harvested material in the receiving container based on data regarding the supply container, the receiving container, and the harvested material; determining, via the visual system, one or more actual fill profile parameters of the harvested material in the receiving container based on vision data from the visual system; determining, via the visual system, an adjustment factor for a fill profile of the harvested material in the receiving container based on a comparison of the plurality of desired fill profile parameters and the one or more actual fill profile parameters; and generating, via the visual system, a second fill profile of the harvested material that accounts for the adjustment factor. Other embodiments of this aspect include corresponding computer systems, apparatus, and computer programs recorded on one or more computer storage devices, each configured to perform the actions of the methods.

Implementations may include one or more of the following features. The method where the plurality of desired fill profile parameters includes any of a first desired fill profile parameter is a maximum weight of harvested material that can be deposited in the receiving container, a second desired fill profile parameter is a desired fill profile type of the harvested material for the receiving container, a third desired fill profile parameter is a weight distribution of the harvested material in the receiving container, a fourth desired fill profile parameter is a maximum fill profile of the harvested material of the receiving container, and/or a fifth desired fill profile parameter is a commodity density of the harvested material. The method may include: determining, via a sensor, the commodity density from a specific type and humidity of the harvested material. The weight distribution of the harvested material across the receiving container includes one of a level distribution, an axle distribution, a front fill distribution, a rear fill distribution, or a reverse fill distribution. The reverse fill distribution includes: loading, via the supply container, a first portion of the harvested material onto a front axle of the receiving container to a fill height that corresponds to the fill profile being a reverse fill profile; and loading, via the supply container, a remaining portion of the harvested material onto a rear axle of the receiving container to a fill height that corresponds to the fill profile being a reverse fill profile. While loading the harvested material into the receiving container includes: moving the supply container in one direction along the receiving container until the fill height corresponds to the fill profile being the reverse fill profile.

The method may include: determining, via the visual system, a floor surface profile along a longitudinal axis and a horizontal axis of a floor of the receiving container. The method may include: determining, via the visual system, a maximum fill profile matrix for the harvested material in the receiving container relative to the floor surface profile. The plurality of desired fill profile parameters includes a desired fill profile parameter being a desired fill profile type of the harvested material for the receiving container, and may include: determining, via the visual system, a profile matrix of the desired fill profile. The method may include: determining, via the visual system, an initial estimated location of the profile matrix relative to the floor surface profile. The method may include: optimizing, via the visual system, the second fill profile of the harvested material in the receiving container to within a weight tolerance or a volume tolerance. The method may include: determining, via the visual system, a minimum shifted profile that includes the maximum fill profile matrix and the initial estimated location of the profile matrix relative to the floor surface profile. The method may include: determining, via the visual system, a desired fill volume and/or a desired fill weight of the harvested material in the receiving container from the minimum shifted profile and the floor surface profile. The method may include: determining, via the visual system, whether the desired fill volume and/or the desired fill weight, respectively, are within a volume tolerance and/or a weight tolerance; when either of the desired fill volume and/or the desired fill weight, respectively, are not within the volume tolerance and/or the weight tolerance, then either increasing or decreasing the adjustment factor; and when both of the desired fill volume and/or the desired fill weight, respectively, are within the volume tolerance and/or the weight tolerance, then determining a two-dimensional profile of the maximum fill matrix of the harvested material in the receiving container. The method may include: displaying information related to the two-dimensional profile of the maximum fill matrix on a visual display.

The method may include: displaying an actual fill height of the harvested material on the visual display; determining, via the visual system, whether the actual fill height is above or below the two-dimensional profile of the maximum fill matrix; and if the actual fill height is below the two-dimensional profile, then the supply container remains in its current location relative to the receiving container as indicated by a nudger position request. Implementations of the described techniques may include hardware, a method or process, or computer software on a computer-accessible medium.

One general aspect includes a visual system for optimizing a fill profile of a harvested material in a receiving container. The visual system also includes a visual processing unit configured to determine a plurality of desired fill profile parameters for a harvested material in the receiving container based on data regarding the supply container, the receiving container, and the harvested material; the visual processing unit configured to determine one or more actual fill profile parameters of the harvested material in the receiving container based on vision data from the visual system, the visual processing unit configured to determine an adjustment factor for a fill profile of the harvested material in the receiving container based on a comparison of the plurality of desired fill profile parameters and the one or more actual fill profile parameter, and the visual processing unit configured to generate a second fill profile of the harvested material that accounts for the adjustment factor to a display unit. Other embodiments of this aspect include corresponding computer systems, apparatus, and computer programs recorded on one or more computer storage devices, each configured to perform the actions of the methods.

Implementations may include one or more of the following features. The visual system where the plurality of desired fill profile parameters includes any of a first desired fill profile parameter is a maximum weight of harvested material that can be deposited in the receiving container, a second desired fill profile parameter is a desired fill profile type of the harvested material for the receiving container, a third desired fill profile parameter is a weight distribution of the harvested material in the receiving container, a fourth desired fill profile parameter is a maximum fill profile of the harvested material of the receiving container, and/or a fifth desired fill profile parameter is a commodity density of the harvested material. The visual processing unit configured to determine a floor surface profile along a longitudinal axis and a horizontal axis of a floor of the receiving container; and where the visual processing unit configured to determine a maximum fill profile matrix for the harvested material in the receiving container relative to the floor surface profile. Implementations of the described techniques may include hardware, a method or process, or computer software on a computer-accessible medium.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a flow diagram of a plurality of desired fill profile parameters for a harvested material in a receiving container of FIG. 2;

FIG. 2 is a side view of a first desired fill profile of the harvested material in the receiving container;

FIG. 3 is a side view of a second desired fill profile of the harvested material in the receiving container;

FIG. 4 is a side view of a third desired fill profile of the harvested material in the receiving container;

FIG. 5 is a side view of a fourth desired fill profile of the harvested material in the receiving container;

FIG. 6 is a side view of a fifth desired fill profile of the harvested material in the receiving container;

FIG. 7 is a flow diagram of a method of adjusting an amount of harvested material that is deposited into the receiving container of FIG. 2;

FIG. 8 is a summary of one or more actual fill parameters of harvested material that is deposited into the receiving container of FIG. 2;

FIG. 9 is a flow diagram of a method of determining a fill profile of harvested material that is deposited into the receiving container of FIG. 2;

FIG. 10 is a schematic of a two-dimensional trailer floor profile of the receiving container of FIG. 2;

FIG. 11 is a three-dimensional trailer floor profile of FIG. 10;

FIG. 12 is a three-dimensional model of a maximum fill level of the harvested material for the three-dimensional trailer floor profile FIG. 11;

FIG. 13 is a three-dimensional model of a profile matrix of any of the desired fill profiles of FIGS. 2-6;

FIG. 14 includes a first of a three-dimensional model of a first initial estimate of a location of the profile matrix illustrated in FIG. 13 and a second of a three-dimensional model of a second initial estimate of a location of the profile matrix illustrated in FIG. 13;

FIG. 15 includes a first of a three-dimensional model of the maximum fill profile from FIG. 12 and either the first initial estimate or the second initial estimate illustrated in FIG. 14 to form a minimum shifted profile illustrated in a second of a three-dimensional model;

FIG. 16 includes a three-dimensional model of and adjusted maximum fill profile that has been adjusted based on the adjustment factor;

FIG. 17 includes a three-dimensional model of an actual fill profile of the harvested material in the receiving container of FIG. 2;

FIG. 18 includes a two-dimensional profile of the FIG. 17 embodiment and a three-dimensional model of a desired fill volume;

FIG. 19 is a first embodiment of a schematic diagram of a system for displaying an actual fill height, a desired fill profile, and a nudger position request on a user interface for an amount of harvested material that is deposited into the receiving container of FIG. 2;

FIG. 20 is a second embodiment of a schematic diagram of a system for displaying an actual fill height, a desired fill profile, and a nudger position request on a user interface for an amount of harvested material that is deposited into the receiving container of FIG. 2; and

FIG. 21 is an exemplary embodiment of a system for use with FIGS. 19 and 20 embodiments.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

In accordance with various embodiments described below, one or more sensors or markers, and one or more cameras are placed on any of a receiving container, a supply container, a tractor, a semi-truck, and/or a combine or harvester. There are alternative locations that the sensors, markers, cameras, or other sensing technology can be mounted or positioned such as on prime movers of receiving or supply containers, drone(s), or a mobile or stationary ground viewing systems, to name a few. The sensors, markers, and/or cameras are part of a visual system that detects and/or determines one or more desired fill profile parameters and one or more actual fill profile parameters. The visual system may continuously or substantially continuously provide information to an automation controller or other suitable device to identify the desired fill profile parameters and the actual fill profile parameters against which a final fill of the receiving container is adjusted and optimized. In some embodiments, the automation controller is included in the visual system. In other embodiments, the automation controller is operatively coupled to the visual system. Although the visual system is described in the application, it should be appreciated that other types of sensing technology that are not “visual” can be used with the present disclosure. Some non-limiting examples include radar, LiDAR or light detection and ranging, ultrasonic, radio waves, electromagnetic waves, to name a few.

In one example, when the visual system is enabled, once the sensor(s) and/or camera(s) is/are used to begin a final fill measurement, the visual system uses real-time measurements of the one or more sensors and/or camera(s) along with any of operator input, machine learning, sensor fusion algorithms, and/or Kalman filter coefficient adjustments to measure and optimize the final fill measurement over time and harvesting of a particular field and particular equipment used for the harvesting.

A supply container or grain cart is typically coupled to a tractor for unloading grain or other harvested material into a receiving container or grain trailer coupled to a semi-truck. During this unloading operation, the truck is usually stationary however may move in some forms, and the operator of the tractor and supply container will typically approach receiving container or trailer from the operator's left side. However, while embodiments will be described with respect to unloading occurring on the operator's left side, it is expressly contemplated that unloading embodiments can be practiced using either side of the supply container or grain cart. In order to initiate the unloading operation, the operator of tractor positions the tractor to drive alongside the receiving container or trailer and will engage suitable hydraulics to fine tune the position of a chute over receiving container or trailer.

One or more camera(s) are mounted on any of the supply container or grain cart or the tractor to image the receiving container and the semi-truck. An automation controller is operatively coupled with the one or more camera(s) to receive and process images from the one or more camera(s) to detect the receiving container. Non-limiting example embodiments of the camera(s) include monocular or stereovision cameras however other types of cameras can be used with the present disclosure.

The operator, automation controller, and/or another controller on the supply container will engage a grain cart auger and control the auger gate position using tractor hydraulics in order to begin the flow of grain or other harvested material through chute from the supply container into the receiving container per a desired fill profile 152, a maximum weight of harvested material, a weight distribution of the harvested material in a receiving container 150, and a maximum fill profile of the harvested material along a length and across a width of the receiving container 150, as described in more detail below. As the harvested material begins to fill the portion of receiving container (described below), the operator and/or automation controller will cause tractor to move in a direction such that a spout of a chute is displaced rearwardly in the receiving container. In this way, the receiving container is generally filled from one direction to another. In one example, this is from the front direction to the rear of the receiving container. However, unloading can also occur with the supply container or grain cart approaching from the opposite side and filling from the rear to the front of receiving container or trailer. Further still, it is also known to fill the receiving container from the rear to the front by operating tractor in reverse.

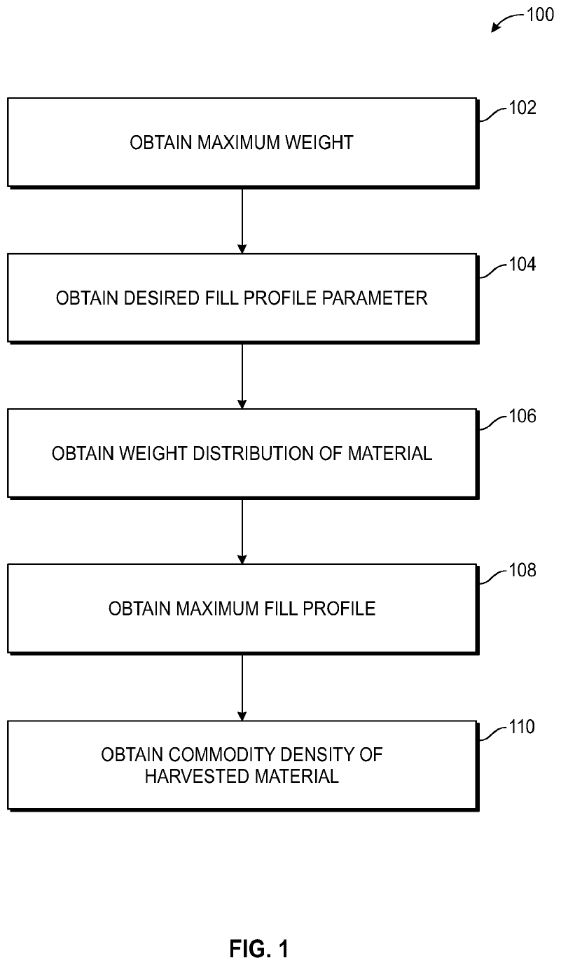

FIG. 1 is a flow diagram of a plurality of desired fill profile parameters 100 for a harvested material in a receiving container 150 in accordance with one embodiment. A first desired fill profile parameter 102 is a maximum weight of harvested material that is to be deposited in the receiving container 150. In some embodiments, the first desired fill profile parameter 102 is a maximum combined weight of harvested material that is to be deposited in the receiving container 150 and the weight of the receiving container 150. It is preferable, but not always necessary, that the first desired fill profile parameter 102 does not exceed a maximum road weight limit. In one embodiment, the supply container 30 along with the harvested material contained in a supply container is measured to determine a maximum weight of harvested material for the first desired fill profile parameter 102. In another embodiment, the weight of an empty supply container i.e., without harvested material therein, is known and the quantity of harvested material accumulated in the supply container is determined and combined with empty receiving container 150 to determine the maximum combined weight for the first desired fill profile parameter 102.

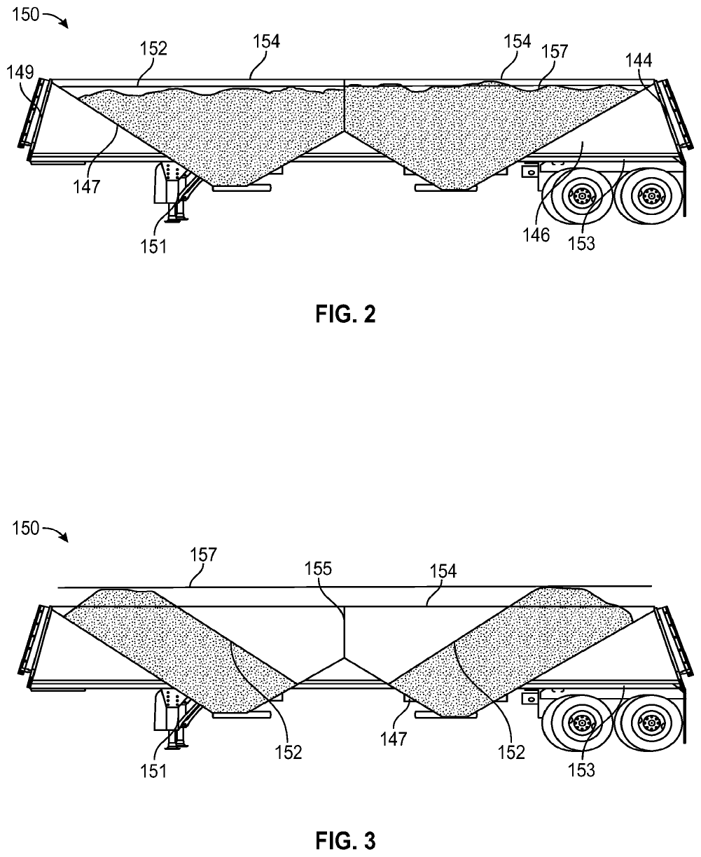

A second desired fill profile parameter 104 of FIG. 1 is a desired fill profile type of the harvested material for the receiving container 150. The second desired fill profile parameter 104 is the desired fill profile 152 as described and illustrated in FIGS. 2-6. The desired fill profile 152 of the receiving container 150 is saved and transmitted with a single list of points and/or a minimum point count to the operator, automation controller, and/or another controller on the supply container. Higher data point counts for the desired fill profile 152 will improve the accuracy of any determined desired fill profiles 152. In one embodiment, a three-dimensional or 3D scan or profile geometry of the receiving container 150 is used in the second desired fill profile parameter 104. In some embodiments, a first one of the receiving container 150 is very similar to a second one of the receiving container 150 therefore the trailer floor profile from the first one of the receiving container 150 can be abstracted out to the second one of the receiving container 150. In other embodiments, certain of one or more receiving container characteristics of the receiving container 150 such as the length, height, and width of the receiving container 150 and a trailer type such as single, double, triple hopper bottom, belt, etc., are used to determine the desired fill profile 152. In some embodiments, a trailer profile can have a few trailer floor points manually measured and loaded into a trailer database or a visual scan of the receiving container 150 can be taken and stored for later use to determine the desired fill profile 152. A higher fidelity of measurements taken will result in better fill accuracy of the harvested material into the receiving container 150, but a low fidelity minimum point entry may have adequate to not require visual scans by the visual system.

An exemplary embodiment of a desired fill profile 152 is illustrated in FIG. 2. The desired fill profile 152 is illustrated as a level fill profile of the harvested material that is deposited in the receiving container 150. The level fill profile of the harvested material tries to achieve an even fill level across a full length of the receiving container 150. In this embodiment, it is preferred that a level height or profile of the harvested material in the receiving container 150 achieves a desired weight distribution of the harvested material. A maximum fill height 157 corresponds to a height or elevation relative to a top edge 154 of the receiving container 150 that the harvested material is preferably deposited in the receiving container 150 to achieve the desired fill profile 152. In the illustrated embodiment, the maximum fill height 157 is below or lower than the top edge 154 of the receiving container 150.

A second exemplary embodiment of the desired fill profile 152 is illustrated in FIG. 3. The desired fill profile 152 in FIG. 3 is an axle fill profile of the harvested material that is deposited in the receiving container 150. The axle fill profile of the harvested material tries to load a majority of the weight of the harvested material onto the front axle placement 151 and the rear axle placement 153 of the receiving container 150. In this embodiment, it is preferred that a desired weight distribution of the harvested material is over the front and rear axles 151 and 153 and that none of the weight of the harvested material is on a hopper divider 155 of the receiving container 150. In the illustrated embodiment, the maximum fill height 157 is above or higher than the top edge 154 of the receiving container 150.

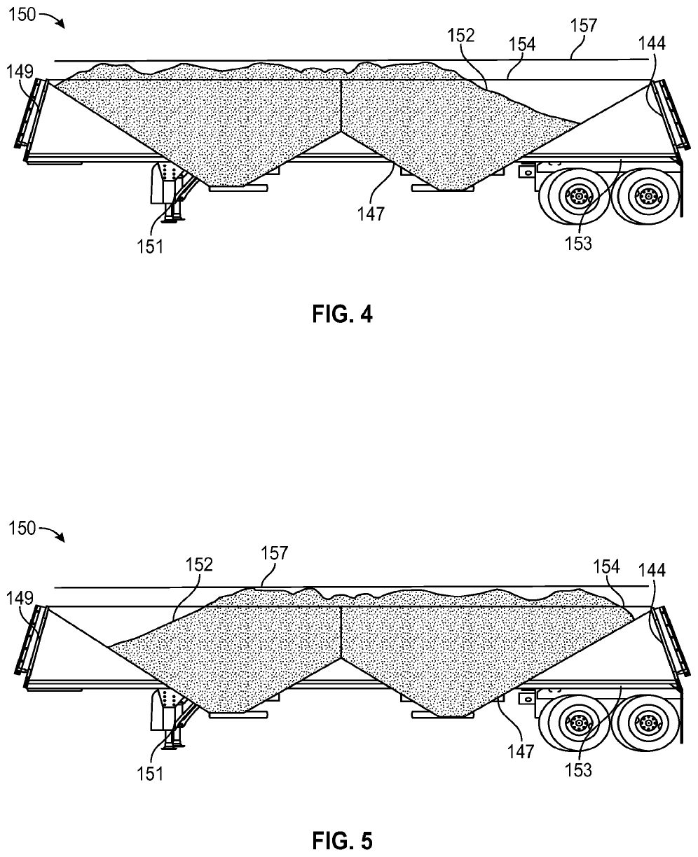

A third exemplary embodiment of the desired fill profile 152 is illustrated in FIG. 4. The desired fill profile 152 in FIG. 4 is a front fill profile of the harvested material that is deposited in the receiving container 150. The front fill profile of the harvested material loads most or a majority of the weight of the harvested material onto the front wall 149 and the front axle placement 151 but away from the rear wall 144 of the receiving container 150. In this embodiment, it is preferred that a desired weight distribution of the harvested material is over the front wall 149, the front axle 151 and that none of the weight of the harvested material is on the rear wall 144. Preferably, a reduced amount of the weight of the harvested material is on the rear axle 153 of the receiving container 150 as compared to an amount of weight of the harvested material on the front axle 151. The front fill profile focuses the weight of the harvested material onto the front axle 151 or semi drive wheels. In the illustrated embodiment, the maximum fill height 157 is above or higher than the top edge 154 of the receiving container 150.

A fourth exemplary embodiment of the desired fill profile 152 is illustrated in FIG. 5. The desired fill profile 152 in FIG. 5 is a rear fill profile of the harvested material that is deposited in the receiving container 150. The rear fill profile of the harvested material loads most or a majority of the weight of the harvested material onto the rear wall 144 and the rear axle placement 153 but away from the front wall 149 of the receiving container 150. In this embodiment, it is preferred that a desired weight distribution of the harvested material is over the rear wall 144, the rear axle 153 and that none of the weight of the harvested material is on the front wall 149. Preferably, a reduced amount of the weight of the harvested material is on the front axle 151 of the receiving container 150 as compared to an amount of weight of the harvested material on the rear axle 153. In the illustrated embodiment, the maximum fill height 157 is above or higher than the top edge 154 of the receiving container 150.

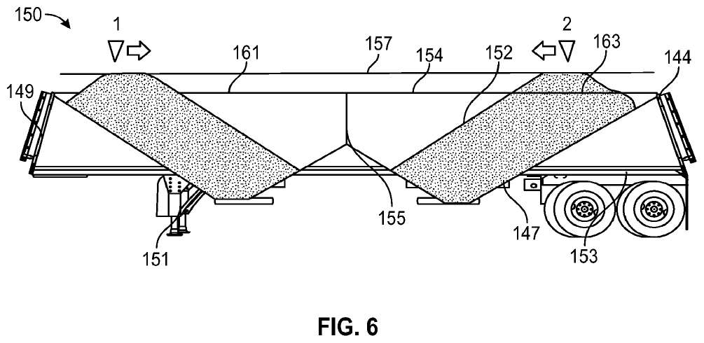

A fifth exemplary embodiment of the desired fill profile 152 is illustrated in FIG. 6. The desired fill profile 152 in FIG. 6 is a reverse fill profile of the harvested material that is deposited in the receiving container 150. The reverse fill profile of the harvested material loads a first portion of the weight of the harvested material onto the front wall 149 and the front axle placement 151 and a second or remaining portion of the weight of the harvested material onto the rear wall 144 and the rear axle placement 153 of the receiving container 150. In prior art embodiments, the tractor (not illustrated) starts unloading at position 1 illustrated in FIG. 6. As the harvested material reaches its desired fill height of the desired fill profile 152, the tractor moves towards the center or the hopper divider 155 of the receiving container 150. Once the desired weight in a front hopper 161 of the receiving container 150 is achieved, the tractor moves to position 2 at the rear hopper 163 as illustrated in FIG. 6. As the grain reaches the desired fill height, the tractor reverses towards the center or the hopper divider 155 of the receiving container 150 until a maximum weight is achieved. However, in the present application since the desired fill profile 152 is known ahead of time or before the tractor or supply container unloads the harvested material into the receiving container 150, therefore the tractor would not need to move from position 1 to position 2 and then reverse to position 1. Instead in the present application, the supply container or tractor would simply fill to the desired fill profile 152 as the supply container or tractor moves in one direction along the receiving container 150. The desired fill profile 152 prevents the need for the tractor or supply container to have to reverse from position 2 and to position 1. Removing the need for the tractor to reverse is quicker for deposition of the harvested material in the receiving container 150 and mitigates any safety concerns with aligning the tractor with the receiving container 150 and moving in both forward and rearward directions for unloading the harvested material. As can be appreciated, this reduces the amount of time required to deposit the harvested material in the receiving container 150. In the illustrated embodiment, the maximum fill height 157 is above or higher than the top edge 154 of the receiving container 150.

Next, a third desired fill profile parameter 106 is a weight distribution of the harvested material in the receiving container 150 is determined. The weight distribution 106 of the harvested material is dependent on the receiving container geometry of the receiving container 150 and an actual weight of harvested material on the front axle 151 and an actual weight of harvested material on the rear axle 153. The actual weight distribution takes into account the position of the harvested material within the receiving container 150. In one embodiment, the weight distribution of the harvested material in the receiving container 150 is determined as a first percentage of weight on the front axle 151 and a second percentage of weight on the rear axle 153. Alternatively, the weight distribution of the harvested material in the receiving container 150 is determined as a first percentage of weight on the front hopper 161 and a second percentage of weight on the rear hopper 163.

Next, a fourth desired fill profile parameter 108 is a maximum fill profile of the harvested material of the receiving container 150 is determined for each of the desired fill profiles 152 described with respect to FIGS. 2-6. It should be appreciated that the desired fill profiles 152 described with respect to FIGS. 2-6 are exemplary and other configurations for the desired fill profiles 152 are within the scope of the present application. Correspondingly, the maximum fill profile of the receiving container 150 is determined for any of the desired fill profiles 152. The maximum fill profile at step 108 is the maximum profile that includes a height of harvested material along a length and width in the receiving container 150 to prevent spillage of the commodity during transport or to prevent exceeding a maximum gross vehicle weight of the harvested material. If the harvested material is above the maximum fill profile of the receiving container 150 then the harvested material may spill over the top edge 154 of the receiving container 150. The maximum fill profile can be influenced by the terrain on which the receiving container 150 is located and an angle of repose of the harvested material or grain. The maximum fill profile is determined as a distance from a top surface 156 of the harvested material, i.e., width, height, and length, relative to the trailer floor surface 147 or bottom profile, i.e., width, height, and length of the trailer floor surface 147 of the receiving container 150 as measured in units such as inches or centimeters. The maximum fill profile can be determined by the user input such as by a semi-truck operator, a farm manager, or a tractor operator, automatically such as by the automation controller, or other techniques.

Next, a fifth desired fill profile parameter 110 being a commodity density of the harvested material is determined. The commodity density of the harvested material can vary with grain type and humidity level. The commodity density of the harvested material is a value with units such as pounds/bushel or kilograms/cubic meter. The humidity level can be sensed by humidity sensors or other detecting means (not illustrated). The humidity sensors can be placed anywhere to contact the harvesting material. For example, the humidity sensors can be placed in the receiving container 150, the supply container, the tractor, or on a combine or harvester that collects the harvested material. In one embodiment, both the humidity and grain type of the harvested material are recorded and stored in the automation controller and/or the harvest systems telematics data. The commodity density of the harvested material can be determined by assuming a commodity density by the operator or receiving a commodity density from an external source. One example of an external source includes a combine providing the density of the grain it is filling into the cart before or after the cart starts its unloading into the receiving container 150.

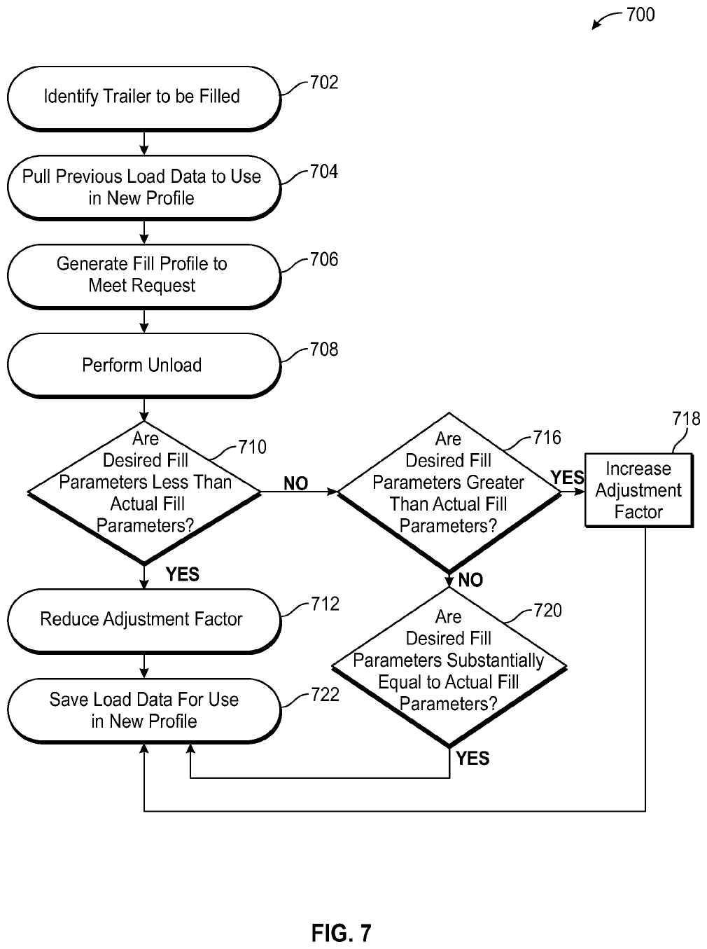

Turning now to FIG. 7 is a method 700 of adjusting an amount of harvested material that is deposited into the receiving container 150. Method 700 employs one or more of the desired fill profile parameters 102, 104, 106, 108, 110, and one or more of steps 702, 704, 706, 708, 710, 712, 714, 716, and/or 718 to determine an adjustment of the amount of the harvested material in the receiving container 150 to maximize the fill profile, maximize the weight of harvested material, and maximize the weight distribution of harvested material in the receiving container 150 according to the desired fill profile 152 illustrated in and selected from FIGS. 2-6. Method 700 can be used with other desired fill profiles 152 that are not illustrated in FIGS. 2-6 as desired.

At step 702, user input such as by a semi-truck operator or a tractor operator, automation controller, and/or other techniques determine or identify a type of receiving container 150 that is to be filled with harvested material from the supply container or tractor. Identification of the receiving container 150 including one or more receiving container characteristics associated with the receiving container 150 is determined. Other types and shapes of receiving containers can be used with the present disclosure. In step 702, one or more receiving container characteristics associated with the receiving container 150 are determined and these one or more receiving container characteristics include a receiving container geometry having a shape and a volume of the receiving container 150 as well as a front axle placement 151 and a rear axle placement 153. The receiving container geometry includes the length, width, and internal dimensions for a trailer floor surface 147 and walls 144, 146, 148 (not illustrated), 149 of the receiving container 150 or the grain trailer. The receiving container 150 can include a sloped or horizontal trailer floor surface 147, sloped or vertical walls 144, 146, 148 (not illustrated), 149, or be configured differently. The trailer floor surface 147 includes a length, a width, and in some embodiments a slope or grade such that the trailer floor surface 147 is not horizontal.

The receiving container geometry may be obtained by a user entering a model number or other suitable information relative to the receiving container geometry, and then the automation controller accessing a data store having receiving container dimensional model information that corresponds to receiving container model numbers. Alternatively, one or more automatic receiving container detection techniques can be used. Examples of automatic receiving container detection can include electronically querying the receiving container, such as by interacting with an RFID tag on the receiving container, optically identifying the receiving container either by measuring its dimensions and position using a camera, or optically identifying visual indicia on the receiving container, such as a QR code or bar code. Additionally, any suitable other technique for obtaining the receiving container model can be provided.

At step 704, user input such as by a semi-truck operator or a tractor operator, automation controller, and/or other techniques determine or identify one or more actual fill parameters 806, 808, 810, 812, and 814, and an adjustment factor 816 as collected from any previous loading operations, if available. The actual fill parameters include an actual fill weight 806, a classification of amount of weight 808, a type of crop 810 that is the harvested material, a crop moisture 812 of the harvested material, and a profile type 814 that corresponds to the desired fill profile 152. As can be appreciated the one or more actual fill parameters relate to the one or more desired fill profile parameters 102, 104, 106, 108, 110.

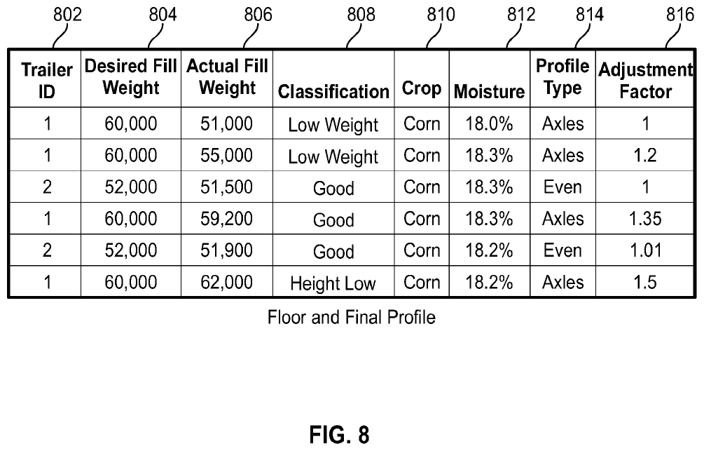

Illustrated in FIG. 8 illustrate six loading operations of harvested material into the receiving container 150 however other embodiments may include more or less loading operations. FIG. 8 is exemplary. FIG. 8 includes a trailer identification 802 and a desired fill weight 804. The trailer identification 802 corresponds to any suitable technique for obtaining the receiving container model and/or receiving container characteristics for the receiving container 150 as described previously. The trailer identification 802 can also have been previously determined in step 702. The desired fill weight 804 corresponds to the first desired fill profile parameter 102.

The actual fill weight 806 is the measured combined weight of the receiving container 150 and the harvested material actually deposited or loaded into the receiving container 150. The classification of amount of weight 808 is determined by user input such as by a semi-truck operator or a tractor operator, automation controller, and/or other techniques to determine a low weight, a good or average weight, a height low, or some other classification that categorizes the amount of weight of the harvested material in the receiving container 150 and indicates whether the actual fill weight 806 is less than the desired fill weight 804. Further, the classification of amount of weight 808 determines if the comparison is within a weight tolerance and catergorizes the comparison.

The type of crop 810 corresponds to the type of the harvested material that is identified and deposited into the receiving container 150. In the illustrated embodiment, the type of crop 810 is corn however other types of crop are intended for the harvested material such as wheat, barley, soybean, or other types.

The crop moisture 812 is the moisture content of the harvested material in a percent form. In the illustrated embodiment, the crop moisture 812 ranges from 18.0% to 18.3%. Although not included in FIG. 8, a commodity density of the harvested material can be included.

The profile type 814 corresponds to the desired fill profile 152 described above with respect to FIGS. 2-6. For example, “Axles” corresponds to FIG. 6 and “Even” corresponds to FIG. 2.

Also illustrated in FIG. 8 is an adjustment factor 816 for each of the loading operations. The adjustment factor 816 is discussed below. The adjustment factor 816 is then applied to a subsequent fill profile for the harvested material that will be deposited into the receiving container 150. As such, the adjustment factor 816 adjusts a future amount of the harvested material that will be deposited into a subsequent receiving container 150.

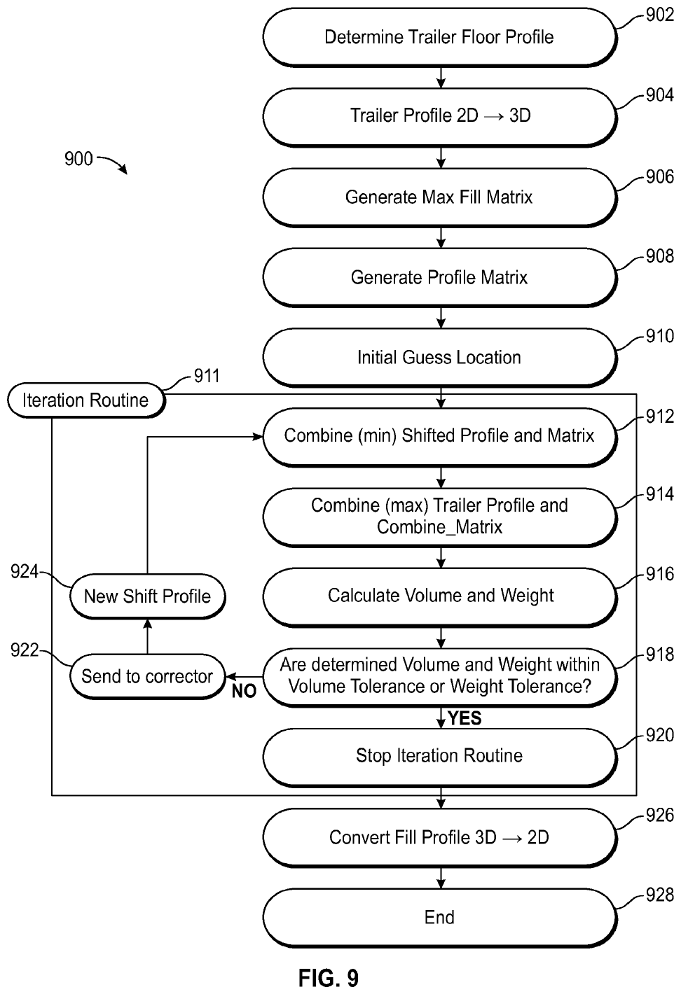

At step 706, user input such as by a semi-truck operator or a tractor operator, automation controller, and/or other techniques determine or identify a new fill profile of the harvested material using the trailer identification 802, desired fill weight 804, actual fill weight 806, the classification of amount of weight 808, the type of crop 810 that is the harvested material, the crop moisture 812 of the harvested material, the profile type 814, and the adjustment factor 816 as discussed below. The new fill profile at step 706 accounts for the one or more of the desired fill profile parameters 102, 104, 106, 108, and 110. The generation of the new fill profile at step 706 is further discussed with respect to method 900 as illustrated in FIG. 9.

At step 708, the harvested material in the supply container is unloaded into the receiving container 150 according to the new fill profile determined in step 706.

At step 710, user input such as by a semi-truck operator or a tractor operator, automation controller, and/or other techniques compares the one or more of the desired fill profile parameters 102, 104, 106, 108, 110 to the one or more actual fill parameters 806, 808, 810, 812, and 814. The comparison in step 710 determines if the one or more of the desired fill profile parameters 102, 104, 106, 108, 110 are less than the one or more actual fill parameters 806, 808, 810, 812, and 814. In particular, if the desired fill weight 804 or the first desired fill profile parameter 102 is less than the actual fill weight 806 then the adjustment factor 816 should be reduced. As such, in step 712 the adjustment factor 816 is reduced. This could be an indication that the actual fill profile of the harvested material in the receiving container 150 is above the maximum desired fill profile. This can also be an indication that the actual fill weight 806 is above the desired fill weight 804. In step 722, the adjustment factor 816 is stored in the automation controller and illustrated in FIG. 8.

If in step 710, the desired fill profile parameters 102, 104, 106, 108, 110 are not less than the one or more actual fill parameters 806, 808, 810, 812, and 814 then at step 716 the method 700 determines if the desired fill profile parameters 102, 104, 106, 108, 110 are greater than the one or more actual fill parameters 806, 808, 810, 812, and 814. In particular, if the desired fill weight 804 or the first desired fill profile parameter 102 is greater than the actual fill weight 806, then the adjustment factor 816 is increased. As such, in step 718 the adjustment factor 816 is increased. This could be an indication that the actual fill profile of the harvested material in the receiving container 150 is below the maximum desired fill profile. This can also be an indication that the actual fill weight 806 is below the desired fill weight 804. In step 722, the adjustment factor 816 is stored in the automation controller and illustrated in FIG. 8.

If in step 716, the desired fill profile parameters 102, 104, 106, 108, 110 are not greater than the one or more actual fill parameters, 806, 808, 810, 812, and 814 then at step 720 the method 700 determines if the desired fill profile parameters 102, 104, 106, 108, 110 are substantially equal to the one or more actual fill parameters 806, 808, 810, 812, and 814. In particular, if the desired fill weight 804 or the first desired fill profile parameter 102 is substantially equal to the actual fill weight 806, then this is an indication that the adjustment factor 816 should remain the same for use in the new profile at step 722.

Turning now to FIG. 9 is a method 900 of determining the new fill profile at step 706. Method 900 employs one or more of the desired fill profile parameters 102, 104, 106, 108, 110, one or more actual fill parameters 802, 804, 806, 808, 810, 812, and 814, and one or more of steps 702, 704, 706, 708, 710, 712, 714, and/or 716 from method 700. The actual weight and/or actual weight distribution is compared to the desired weight and/or desired weight distribution of the harvested material.

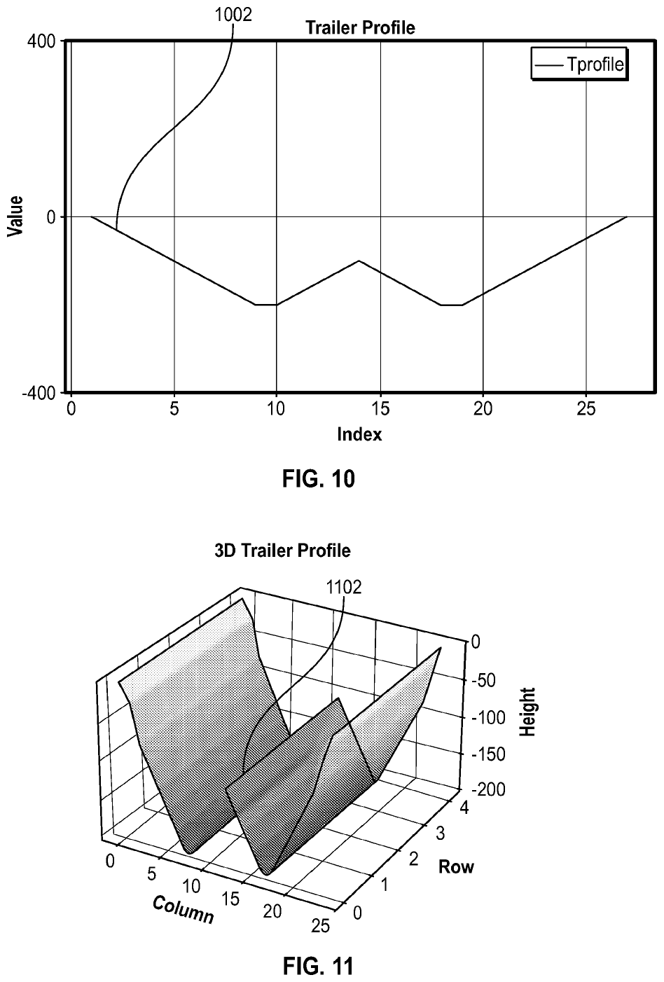

At step 902, user input such as by a semi-truck operator or a tractor operator, automation controller, and/or other techniques are used to determine a trailer floor profile 1002 along a longitudinal axis of the trailer floor of the receiving container 150 is illustrated in FIG. 10. In one embodiment, the visual system determines if the receiving container 150 is covered and not accessible. If the receiving container 150 is not covered and/or is accessible, then the visual system determines if any harvested material is present in the receiving container 150. The visual system determines if none of the harvested material is present in the receiving container 150, i.e., the receiving container 150 is empty. The trailer floor profile 1002 can be determined at step 702 discussed above.

In step 904, the trailer floor profile 1002 is converted from a two-dimensional or 2D configuration to a three-dimensional or 3D configuration as illustrated in a trailer floor surface profile 1102 as illustrated in FIG. 11.

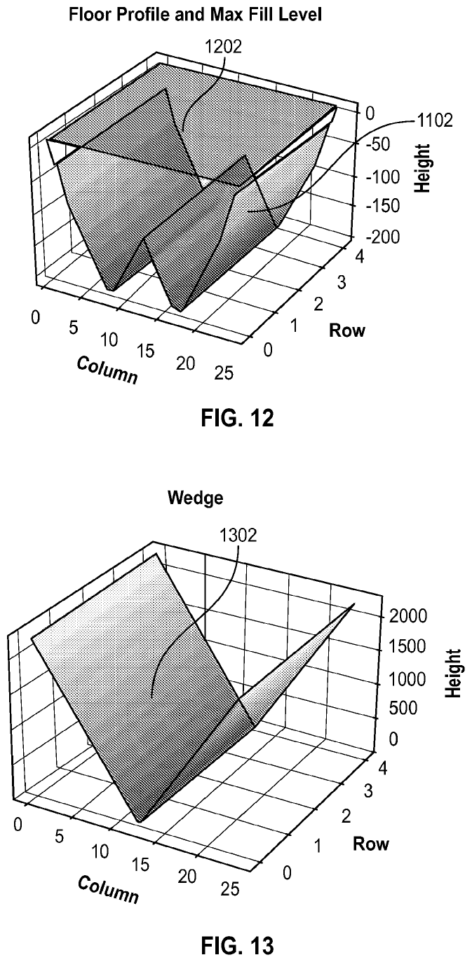

At step 906, user input such as by a semi-truck operator or a tractor operator, automation controller, and/or other techniques are used to determine a maximum fill profile matrix 1202 for the harvested material in the receiving container 150 as modeled on the trailer floor surface profile 1102 as illustrated in FIG. 12. The maximum fill profile matrix 1202 is illustrated as a horizontal surface or plane on the trailer floor surface profile 1102; however, in other embodiments the maximum fill profile matrix 1202 is shaped differently such as an inverted V shape, a wedge shape, or other shape that mimics the harvested material placement in the receiving container 150. The maximum fill profile matrix 1202 is the maximum fill height for the harvested material in the receiving container 150.

At step 908, user input such as by a semi-truck operator or a tractor operator, automation controller, and/or other techniques are used to determine a profile matrix 1302 of the desired fill profile from step 104 is determined as illustrated in FIG. 13. The profile matrix 1302 corresponds to the commodity angle of repose of the harvested material as illustrated with the desired fill profile 152 in FIG. 6. The automation controller determines the commodity angle of repose of the harvested material that is placed in the receiving container 150 for FIG. 6. As can be appreciated, the profile matrix 1302 corresponds to the desired fill profile from step 104 and in other embodiments may have a different configuration than illustrated in FIG. 13. As such, in other embodiments, the profile matrix 1302 may resemble any of the desired fill profiles 152 from FIGS. 2-5, or other configurations.

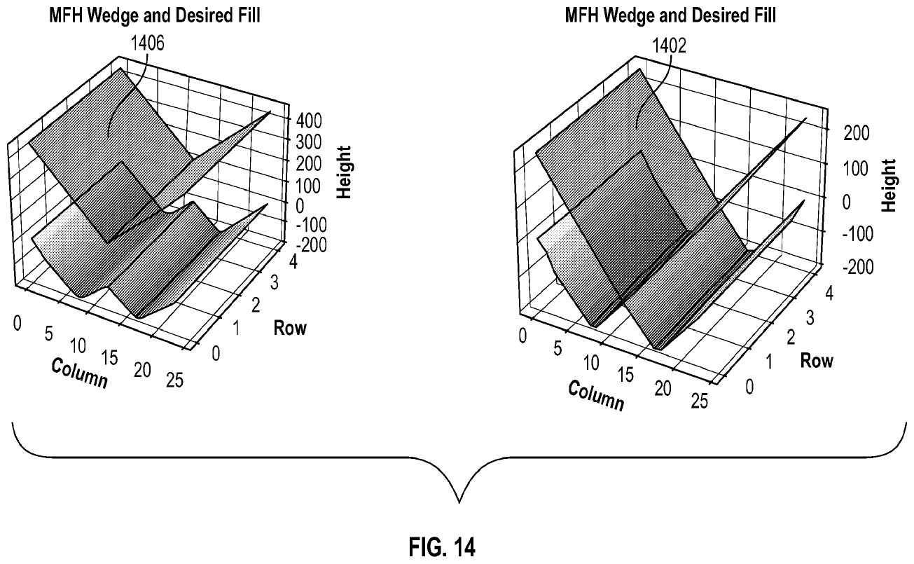

At step 910, user input such as by a semi-truck operator or a tractor operator, automation controller, and/or other techniques are used to determine a first initial estimate 1402 of a location of the profile matrix 1302 is illustrated in FIG. 14. Alternatively, a second initial estimate 1406 of a location of the profile matrix 1302 is illustrated in FIG. 14. The first initial estimate 1402 is positioned closer to the trailer floor surface profile 1102 as compared to the second initial estimate 1406 that is positioned further away from the trailer floor surface profile 1102.

At step 911, user input such as by a semi-truck operator or a tractor operator, automation controller, and/or other techniques are used in an iteration routine to optimize a fill profile of the harvested material in the receiving container 150 that is within a weight tolerance and/or a volume tolerance.

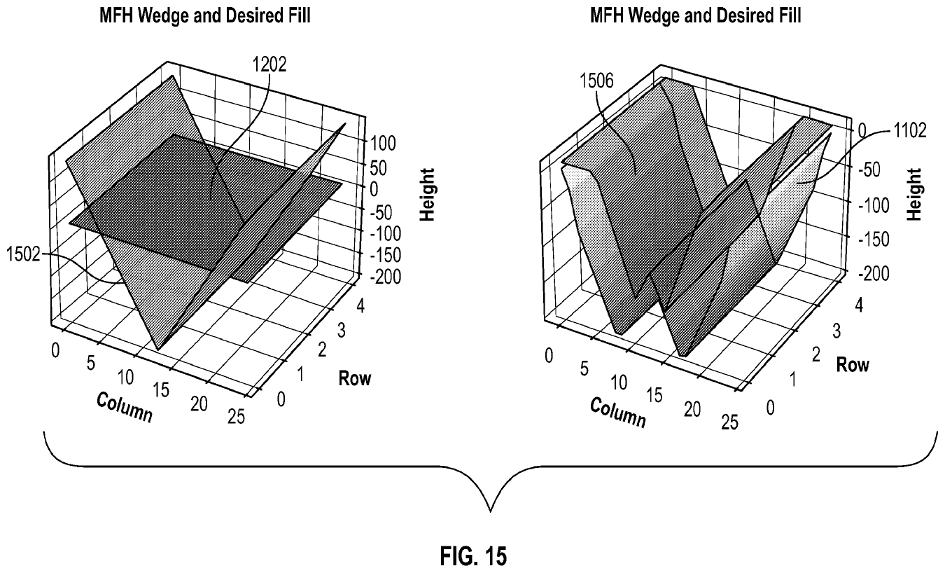

In step 912, user input such as by a semi-truck operator or a tractor operator, automation controller, and/or other techniques are used to combine the maximum fill profile matrix 1202 using either the first initial estimate 1402 or the second initial estimate 1406 illustrated in FIG. 14 to create a minimum shifted profile 1506 in FIG. 15. It is desired that a minimum height is used for each of the maximum fill profile matrix 1202 and either the first initial estimate 1402 or the second initial estimate 1406 to determine the minimum shifted profile 1506. The minimum shifted profile 1506 is a three-dimensional profile.

In step 914, user input such as by a semi-truck operator or a tractor operator, automation controller, and/or other techniques are used to combine the minimum shifted profile 1506 and the trailer floor surface profile 1102 from step 912. The combination of the minimum shifted profile 1506 and the trailer floor surface profile 1102 form a desired fill volume 1508. The minimum shifted profile 1506 is a maximum fill matrix 1702 as illustrated in FIG. 17 that represents the actual fill profile of the harvested material in the receiving container 150.

In step 916, user input such as by a semi-truck operator or a tractor operator, automation controller, and/or other techniques are used to determine a volume and a weight of the desired fill volume 1508 for the receiving container 150. Since the density of the harvested material is known, the volume and weight of the harvested material that is placed in the receiving container 150 is determined based on the type of crop 810 and the crop moisture 812.

In step 918, user input such as by a semi-truck operator or a tractor operator, automation controller, and/or other techniques are used to determine whether the volume and weight of the desired fill volume 1508 for the receiving container 150, respectively, are within a volume tolerance and/or a weight tolerance. If both of these are within their respective tolerances, then the iteration routine of step 911 ends at step 920 and the next step 926 is generated as described below. If either of these are not within their respective tolerances, then the iteration routine of step 911 continues to step 922 where the maximum fill profile matrix 1202 is adjusted either higher relative to the trailer floor surface profile 1102 to increase the amount of the harvested material that is deposited into the receiving container 150 or adjusted lower relative to the trailer floor surface profile 1102 to decrease the amount of the harvested material that is deposited into the receiving container 150. Accordingly, this increase or decrease of the maximum fill profile matrix 1202 is accomplished by the adjustment factor 816 is determined as described above.

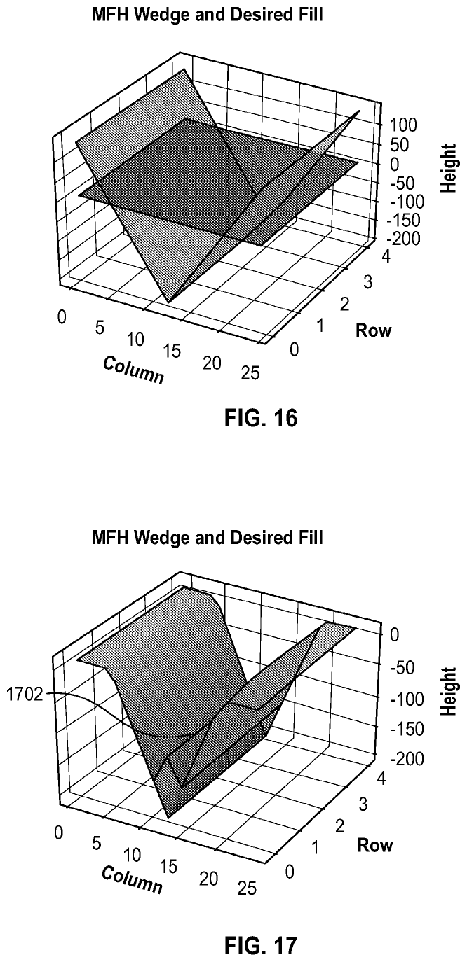

In step 924, user input such as by a semi-truck operator or a tractor operator, automation controller, and/or other techniques are used to determine an adjusted maximum fill profile 1602 as discussed above with step 706. The adjusted maximum fill profile 1602 accounts for the adjustment factor 816. Illustrated in FIG. 16 is the adjusted maximum fill profile 1602 that has been adjusted based on the adjustment factor 816.

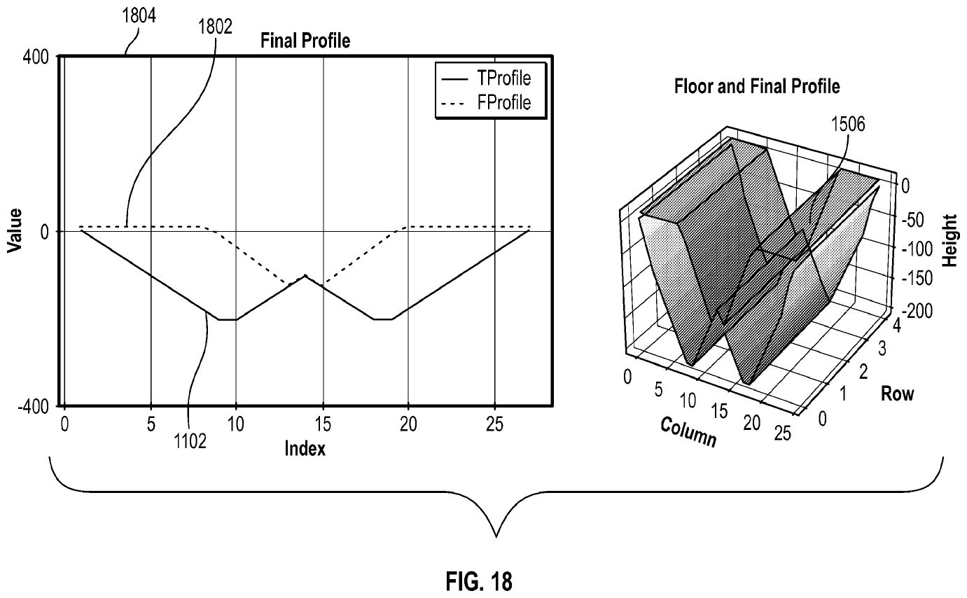

Continuing from step 920 to step 926, user input such as by a semi-truck operator or a tractor operator, automation controller, and/or other techniques are used to determine or convert the maximum fill matrix 1702 as illustrated in FIG. 17 that represents the three-dimensional fill profile of the harvested material in the receiving container 150 into a two-dimensional profile 1802 in FIG. 18 that can be displayed on a user interface 1804 for the semi-truck operator or a tractor operator, automation controller, and/or other techniques to implement when depositing the harvested material into the receiving container 150. At step 928, the method 900 ends.

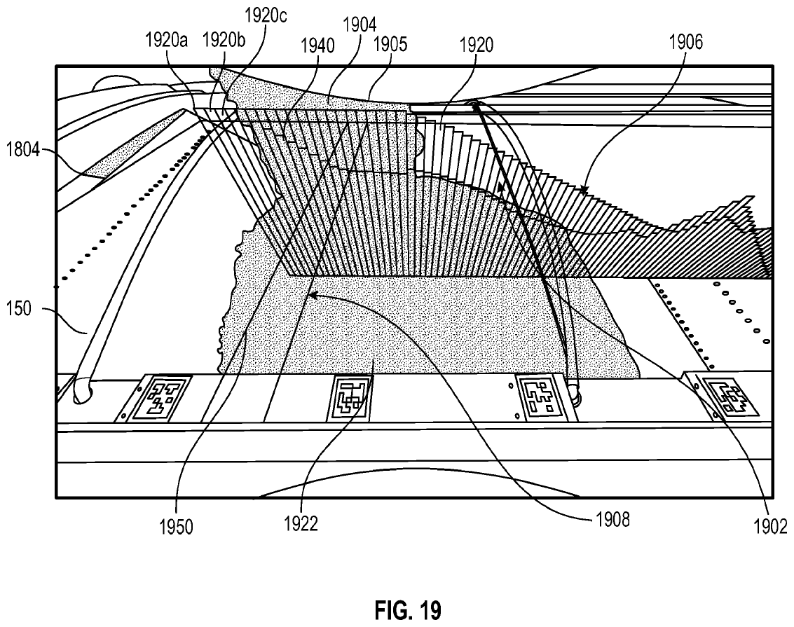

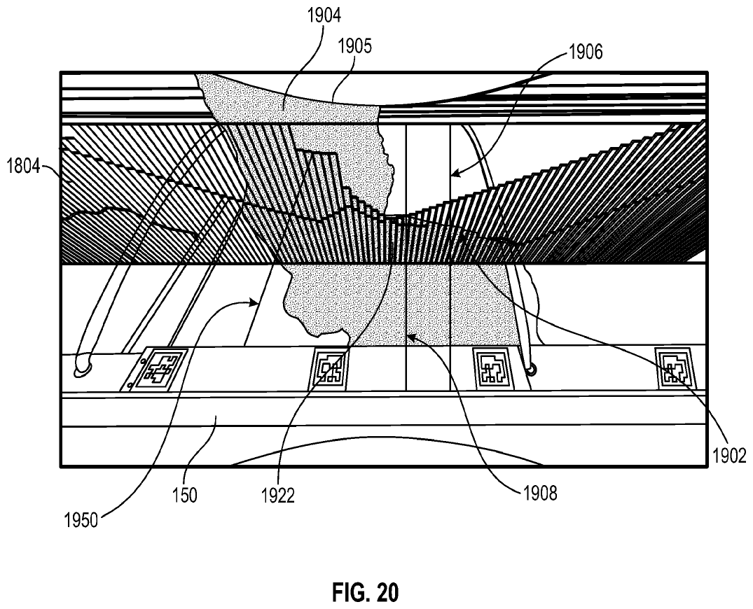

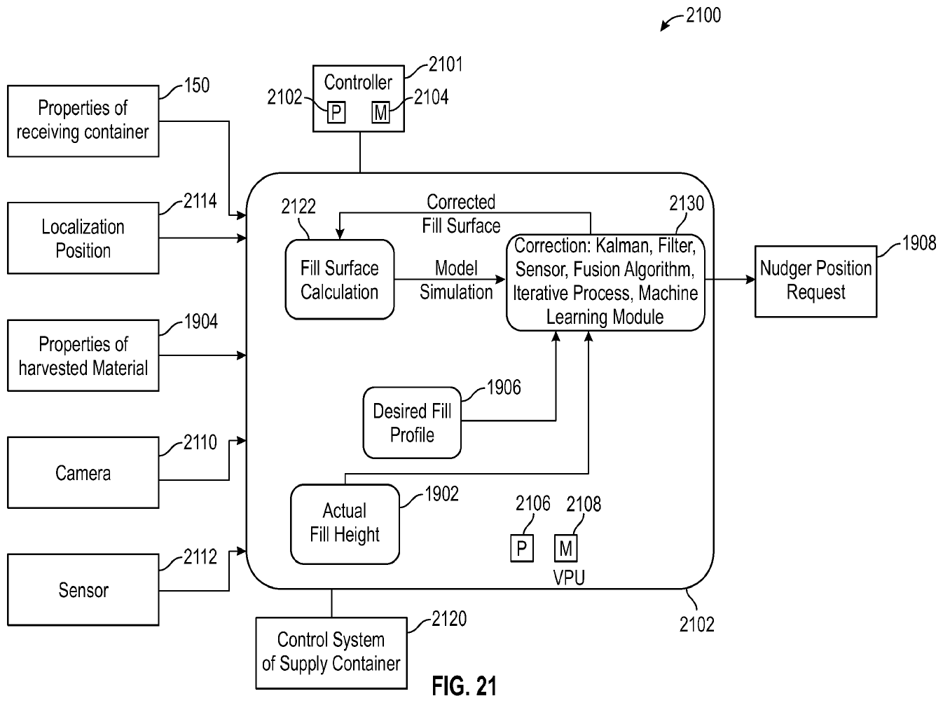

To unload the harvested material from the cart, the supply container employs a conveying device to draw harvested material from the bottom of the supply container and carry it through a chute 1905 that deposits the harvested material wherever it is needed. To provide power to the auger, the supply container is typically driven by a Power Take-Off (“PTO”) driveshaft located at the rear end of the tractor. At the bottom of the supply container, where the auger meets the bottom of the supply container, is a hopper gate that must be opened for harvested material to flow onto the auger. The hopper gates are actuated and are powered by tractor's hydraulics or electricals. The hopper gates keep the harvested material in the supply container until the operator desires to remove the harvested material. In FIGS. 19 and 20, the harvested material from the supply container is being deposited into the receiving container 150.

With reference to FIGS. 19, 20, and 21, a visual system 2100 includes a vision processing unit (VPU) 2102, which can have one or more microprocessor-based electronic control units or controllers 2101. The controller 2101 includes a processor 2102 and a memory 2104. The VPU 2102 can also include a processor 2106 and a memory 2108 having instructions for execution by the processor 2106. The VPU 2102 can receive various inputs including a feed from a camera 2110 or other sensor 2112, a localization position 2114 of the camera 2110 relative to a GPS location of the towing vehicle or supply container from a GPS sensor, properties of the harvested material 1904, and properties of the receiving container 150, as previously discussed. The feed from the camera 2110 can include raw or processed data or images. The localization position 2114 can include one or more of a position of the tractor, a position of the supply container, a position of the auger, and a position of the camera. The VPU 2102 can receive supply container operational information from a control system 2120 of the supply container, for example an electronic control unit (ECU) having a controller with a processor and memory, regarding the unloading rate of harvested material and the auger position. The VPU 2102 can receive visual information from the camera 2110 or other sensor regarding the actual fill height 1902 of the harvested material 1904 in the receiving container 150.

The VPU 2102 performs a fill surface calculation 2122 based on the receiving container information from the properties of the receiving container 150, the localization position 2114, and the supply container information from the control system 2120 of the supply container. The fill surface calculation 2122 results in a model simulation of the actual fill height 1902 of the harvested material 1904. The VPU 2102 performs a comparison and/or correction 2130 based on the actual fill height 1902 of the harvested material 1904, a desired fill profile 1906, and a current unload position 1950 of the chute 1905 from the control system 2120 of the supply container. The comparison 2130 can include a Kalman filter, a sensor fusion algorithm, an iterative process, a machine learning model, or other techniques to update the model simulation of the actual fill height 1902 of the harvested material 1904. The VPU 2102 can display the actual fill height 1902 of the harvested material 1904 on a local or remote display or user interface 1804, for example any local or remote electronic device with a screen or monitor. The VPU 2102 can display the desired fill profile 1906 and a nudger position request 1908 on the local or remote display or user interface 1804.

Turning now to FIG. 19 is a first embodiment of a schematic diagram of a system for displaying an actual fill height profile 1902, a desired fill profile 1906, and a nudger position request 1908 on the user interface 1804. The actual fill height profile 1902 overlays the desired fill profile 1906. The actual fill height profile 1902 corresponds to the amount or height of the harvested material 1904 that is deposited into the receiving container 150 and is determined in real time as the operator is depositing the harvested material 1904 into the receiving container 150.

The desired fill profile 1906 includes a one-dimensional grid 1920 calculated as one-dimensional slices 1920a, 1920b, 1920c, . . . 1920xx or as many slices as desired. Each of the one-dimensional slices 1920a . . . 1920xx has the same width. Each of the one-dimensional slices 1920a . . . 1920xx may have a unique height. The desired fill profile 1906 corresponds to the two-dimensional profile 1802 that was determined above in step 926 in method 900.

The actual fill height profile 1902 includes a one-dimensional grid 1940 calculated as one-dimensional slices 1940a, 1940b, 1940c, . . . 1940xx and corresponds to the same width as the one-dimensional slices 1920a, 1920b, 1920c, . . . 1920xx of the desired fill profile 1906. Each of the one-dimensional slices 1940a . . . 1940xx may have a unique height and optimally the height of the one-dimensional slices 1940a . . . 1940xx corresponds to the height of the one-dimensional slices 1920a . . . 1920xx.

In this example the harvested material 1904 forms a commodity pile 1922. As the harvested material 1904 is deposited into the receiving container 150, the actual fill height profile 1902 that overlays the desired fill profile 1906 will be updated based on the location of the harvested material 1904 in the receiving container 150. At this current unload position of the supply container relative to the receiving container 150 illustrated in FIG. 19, the actual fill height 1902 is below the desired fill profile 1906 which indicates that the amount of harvested material 1904 that was deposited or is being deposited into the receiving container 150 is less than the amount required by the desired fill profile 1906. In this situation, user input such as by a semi-truck operator or a tractor operator, automation controller, and/or other techniques are used to determine that the supply container should remain in its current location relative to the receiving container 150 as indicated by the nudger position request 1908. The nudger position request 1908 indicates a location that the chute of the supply container should be relative to the receiving container 150 to deposit the harvested material 1904 into the receiving container 150 to optimize filling the receiving container 150. Optimization includes depositing the harvested material 1904 in the receiving container 150 such that the actual fill height profile 1902 corresponds to the desired fill profile 1906. Optimization of the actual fill height profile 1902 to the desired fill profile 1906 accounts for commodity moisture changes resulting in different commodity density and different angles of repose of the commodity or the harvested material 1904.

Turning now to FIG. 20 is illustrated a later time period wherein the harvested material 1904 has been deposited in the receiving container 150. At this current unload position of the supply container relative to the receiving container 150 illustrated in FIG. 20, the actual fill height 1902 is above the desired fill profile 1906 which indicates that the amount of harvested material 1904 that was deposited or is being deposited into the receiving container 150 is more than the amount required by the desired fill profile 1906. In this situation, user input such as by a semi-truck operator or a tractor operator, automation controller, and/or other techniques are used to determine that the supply container should move away from its current location relative to the receiving container 150 as indicated by the nudger position request 1908.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. A method of optimizing a fill profile of a harvested material in a receiving container, the method comprising:
determining, via a visual system, a plurality of desired fill profile parameters for a harvested material in the receiving container based on data regarding the supply container, the receiving container, and the harvested material;
determining, via the visual system, one or more actual fill profile parameters of the harvested material in the receiving container based on vision data from the visual system;
determining, via the visual system, an adjustment factor for a fill profile of the harvested material in the receiving container based on a comparison of the plurality of desired fill profile parameters and the one or more actual fill profile parameters; and
generating, via the visual system, a second fill profile of the harvested material that accounts for the adjustment factor.

2. The method of claim 1, wherein the plurality of desired fill profile parameters includes any of a first desired fill profile parameter is a maximum weight of harvested material that can be deposited in the receiving container, a second desired fill profile parameter is a desired fill profile type of the harvested material for the receiving container, a third desired fill profile parameter is a weight distribution of the harvested material in the receiving container, a fourth desired fill profile parameter is a maximum fill profile of the harvested material of the receiving container, and/or a fifth desired fill profile parameter is a commodity density of the harvested material.

3. The method of claim 2, further comprising:
determining, via a sensor, the commodity density from a specific type and humidity of the harvested material.

4. The method of claim 2, wherein the weight distribution of the harvested material across the receiving container includes one of a level distribution, an axle distribution, a front fill distribution, a rear fill distribution, or a reverse fill distribution.

5. The method of claim 4, wherein the reverse fill distribution includes:
loading, via the supply container, a first portion of the harvested material onto a front axle of the receiving container to a fill height that corresponds to the fill profile being a reverse fill profile; and
loading, via the supply container, a remaining portion of the harvested material onto a rear axle of the receiving container to a fill height that corresponds to the fill profile being a reverse fill profile.

6. The method of claim 5, wherein while loading the harvested material into the receiving container includes:
moving the supply container in one direction along the receiving container until the fill height corresponds to the fill profile being the reverse fill profile.

7. The method of claim 1, further comprising:
determining, via the visual system, a floor surface profile along a longitudinal axis and a horizontal axis of a floor of the receiving container.

8. The method of claim 7, further comprising:
determining, via the visual system, a maximum fill profile matrix for the harvested material in the receiving container relative to the floor surface profile.

9. The method of claim 8, wherein the plurality of desired fill profile parameters includes a desired fill profile parameter being a desired fill profile type of the harvested material for the receiving container, and further comprising:
determining, via the visual system, a profile matrix of the desired fill profile.

10. The method of claim 9, further comprising:
determining, via the visual system, an initial estimated location of the profile matrix relative to the floor surface profile.

11. The method of claim 10, further comprising:
optimizing, via the visual system, the second fill profile of the harvested material in the receiving container to within a weight tolerance or a volume tolerance.

12. The method of claim 11, further comprising:
determining, via the visual system, a minimum shifted profile that includes the maximum fill profile matrix and the initial estimated location of the profile matrix relative to the floor surface profile.

13. The method of claim 12, further comprising:
determining, via the visual system, a desired fill volume and/or a desired fill weight of the harvested material in the receiving container from the minimum shifted profile and the floor surface profile.

14. The method of claim 13, further comprising:
determining, via the visual system, whether the desired fill volume and/or the desired fill weight, respectively, are within a volume tolerance and/or a weight tolerance;
when either of the desired fill volume and/or the desired fill weight, respectively, are not within the volume tolerance and/or the weight tolerance, then either increasing or decreasing the adjustment factor; and
when both of the desired fill volume and/or the desired fill weight, respectively, are within the volume tolerance and/or the weight tolerance, then determining a two-dimensional profile of the maximum fill matrix of the harvested material in the receiving container.

15. The method of claim 14, further comprising:
displaying information related to the two-dimensional profile of the maximum fill matrix on a visual display.

16. The method of claim 15, further comprising:
displaying an actual fill height of the harvested material on the visual display;
determining, via the visual system, whether the actual fill height is above or below the two-dimensional profile of the maximum fill matrix; and
if the actual fill height is below the two-dimensional profile, then the supply container remains in its current location relative to the receiving container as indicated by a nudger position request.

17. A visual system for optimizing a fill profile of a harvested material in a receiving container, the system comprising:
a visual processing unit configured to determine a plurality of desired fill profile parameters for a harvested material in the receiving container based on data regarding the supply container, the receiving container, and the harvested material;
the visual processing unit configured to determine one or more actual fill profile parameters of the harvested material in the receiving container based on vision data from the visual system;
the visual processing unit configured to determine an adjustment factor for a fill profile of the harvested material in the receiving container based on a comparison of the plurality of desired fill profile parameters and the one or more actual fill profile parameter; and
the visual processing unit configured to generate a second fill profile of the harvested material that accounts for the adjustment factor to a display unit.

18. The visual system of claim 17, wherein the plurality of desired fill profile parameters includes any of a first desired fill profile parameter is a maximum weight of harvested material that can be deposited in the receiving container, a second desired fill profile parameter is a desired fill profile type of the harvested material for the receiving container, a third desired fill profile parameter is a weight distribution of the harvested material in the receiving container, a fourth desired fill profile parameter is a maximum fill profile of the harvested material of the receiving container, and/or a fifth desired fill profile parameter is a commodity density of the harvested material.

19. The visual system of claim 17, wherein the visual processing unit configured to determine a floor surface profile along a longitudinal axis and a horizontal axis of a floor of the receiving container; and
wherein the visual processing unit configured to determine a maximum fill profile matrix for the harvested material in the receiving container relative to the floor surface profile.

20. The visual system of claim 19, wherein the visual processing unit is further configured to optimize the second fill profile of the harvested material in the receiving container to within a weight tolerance or a volume tolerance.
